(19) United States
(12) Patent Application Publication
(10) Pub. No.: US 2015/0042968 A1
(43) Pub. Date: Feb. 12, 2015

(54) Light Source Apparatus, Projection Display Apparatus, and Illumination Method

(71) Applicant: Masami Takauchi, Tokyo (JP)

(72) Inventor: Masami Takauchi, Tokyo (JP)

(21) Appl. No.: 14/385,114

(22) PCT Filed: Mar. 23, 2012
(86) PCT No.: PCT/JP2012/057427

§ 371 Date: Sep. 12, 2014

(51) Int. Cl. F21V 8/00; G03B 21/28; G03B 21/20

(52) U.S. Cl. CPC G02B 6/0096; G03B 21/20; G03B 21/2053; G03B 21/28
USPC 353/99; 362/551

(57) ABSTRACT

Provided is a light source apparatus that includes light emitting tube (21), light pipe (23) which has incident surface (23a) into which light from light emitting tube (21) enters and which has exit surface (23b) from which light that has entered incident surface (23a) is subjected to multiplex reflection to be output, lens (25) into which the light output from exit surface (23b) enters, first parabolic reflection mirror (26) that reflects a part of the light that is output from exit surface (23b) and that does not enter lens (25), and second parabolic reflection mirror (27) which makes the light reflected by first parabolic reflection mirror (26) enter incident surface (23a).

### TECHNICAL FIELD

The present invention relates to a light source apparatus which makes light from a light source enter a light guide body and which makes the light emitted from the light guide body enter an optical element, a projection display apparatus including the light source apparatus, and an illumination method.

### BACKGROUND ART

A certain projection display apparatus uses a light source apparatus which is configured to make light from a light emitting tube serving as a light source enter into a light pipe serving as a light guide body and which is configured to output the light uniform in luminance from the light pipe (e.g., refer to Patent Literatures 1 and 2).

As shown in FIG. 6, light source apparatus 111 related to the present invention includes light emitting tube 121, elliptic reflection mirror 122 that converges light from light emitting tube 121, light pipe 123, that has incident surface 123a into which the light converged by elliptic reflection mirror 122 enters and that has exit surface 123b from which light that has entered incident surface 123a is subjected to multiplex reflection to be output, and lens 125 into which the light that is output from exit surface 123b enters.

The light that entered lens 125 from exit surface 123b of light pipe 123 is guided along the optical path of an optical system, and is applied to an optical modulation element to be modulated, and is projected on a projection surface by a projection lens.

### CITATION LIST

Patent Literature 1: JP2005-292358A

Patent Literature 2: JP2006-106525A

### SUMMARY OF INVENTION

### Problems to be Solved by Invention

As described above, in light source apparatus 111 related to the present invention, part P of the light output from light pipe 123 leaks from the optical path without entering lens 125. Thus, it is preferable to increase the use efficiency of the light which is emitted from light emitting tube 121.

To prevent part P of the light emitted from light pipe 123 from leaking from the optical path so that the amount of light that entered from light pipe 123 into lens 125 can be increased, the diameter of lens 125 may be increased. However, when the diameter of lens 125 is increased, the optical system is enlarged, thus increasing the overall size of the projection display apparatus.

To prevent part P of the light emitted from light pipe 123 from leaking from the optical path so that the light that entered from light pipe 123 into lens 125 can be increased, lens 125 may be disposed close to exit surface 123b of light pipe 123. However, even when lens 125 is disposed close to exit surface 123b of light pipe 123, the light that entered into lens 125 depends on the numerical aperture of lens 125, and the increased light that entered into lens 125 from light pipe 123 may not necessarily lead to an increase of the light guided along the optical path that continues from lens 125.

It is therefore an object of the present invention to provide a light source apparatus, a projection display apparatus, and an illumination method capable of solving the aforementioned problems of the related art. The exemplary object of the present invention is to provide a light source apparatus, a projection display apparatus, and an illumination method capable of reducing power consumption and improving brightness by reusing a part of light that is emitted from a light source and that leaked from an optical path because it was not captured in an optical element.

### Solution to Problem

To achieve the object, a light source apparatus according to the present invention includes a light source, a light guide body which has an incident surface into which light from the light source enters and which has an exit surface from which light that has entered the incident surface is subjected to multiplex reflection to be output, and an optical element into which the light output from the exit surface enters, a first reflection mirror that reflects a part of the light that is output from the exit surface and that does not enter the optical element, and a second reflection mirror which makes the light reflected by the first reflection mirror enter the incident surface.

A projection display apparatus according to the present invention includes the light source apparatus of the present invention, and an optical modulation element that modulates the light from the light source apparatus.

To achieve the object, an illumination method according to the present invention includes entering light from a light source into the incident surface of a light guide body, subjecting the light which enters the incident surface to multiplex reflection in the light guide body to output the light from an exit surface, and entering the light output from the exit surface into the optical element. A part of the light that is output from the exit surface and that does not enter the optical element is reflected to enter the incident surface.

### Effects of Invention

According to the present invention, power consumption can be reduced and brightness can be improved by reusing a part of the light that is emitted from the light source and that leaked from the optical path because it was not captured in the optical element.

### BRIEF DESCRIPTION OF DRAWINGS

FIG. 1 A schematic diagram illustrating a projection display apparatus according to a first embodiment.

FIG. 2 A schematic diagram illustrating a light source apparatus according to the first embodiment.

FIG. 3 A schematic diagram illustrating the components of the light source apparatus according to the first embodiment.

FIG. 4 A schematic diagram illustrating the state of rays in the light source apparatus according to the first embodiment.

FIG. 5 A schematic diagram illustrating a light source apparatus according to a second embodiment.

FIG. 6 A schematic diagram illustrating a light source apparatus related to the present invention.

### DESCRIPTION OF EMBODIMENTS

Hereinafter, the specific embodiments of the present invention will be described with reference to the drawings.

### First Embodiment

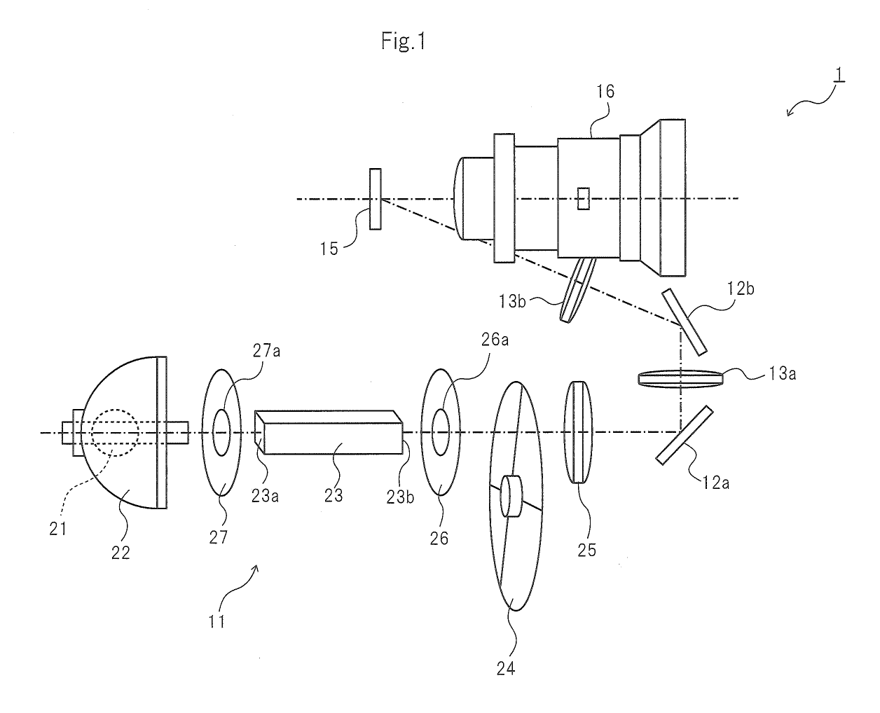

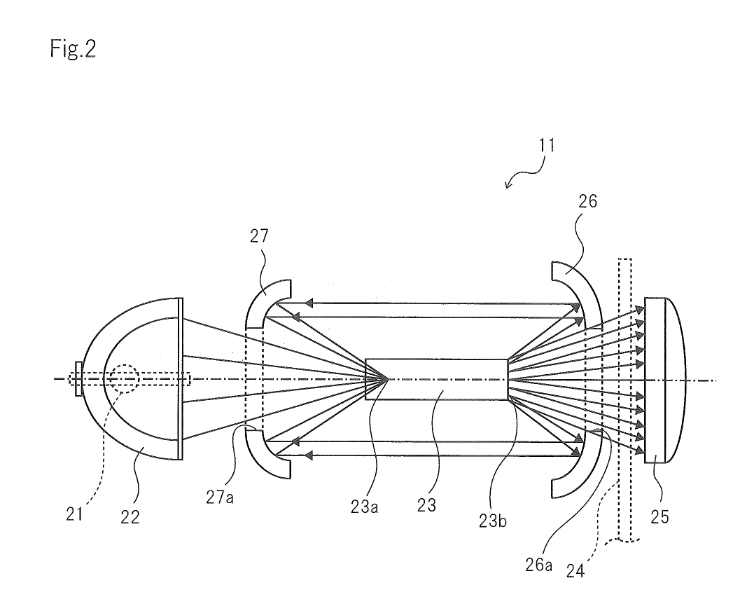

FIG. 1 shows a schematic diagram illustrating a projection display apparatus according to a first embodiment. FIG. 2 shows a schematic diagram illustrating a light source apparatus according to the first embodiment.

As shown in FIG. 1, projection display apparatus 1 includes light source apparatus 11, mirror group 12a, 12b and mirror group 13a, 13b which comprise an optical path from light source apparatus 11, reflective display element 15 that is an optical modulation element for modulating light from light source apparatus 11, and projection lens 16 for projecting the light which comes from reflective display element 15 onto a projection surface. A DMD (Digital Micromirror Device) is used for reflective display element 15.

As shown in FIGS. 1 and 2, light source apparatus 11 included in projection display apparatus 1 includes light emitting tube 21 serving as a light source, elliptic reflection mirror 22 that converges light from light emitting tube 21, light pipe 23 serving as a light guide body that includes incident surface 23a into which the light converged by elliptic reflection mirror 22 enters and exit surface 23b from which light that has entered incident surface 23a is subjected to multiplex reflection to be output, lens 25 serving as an optical element into which the light output from exit surface 23b enters, first parabolic reflection mirror 26 serving as a first reflection mirror that reflects a part of the light that is output from exit surface 23b and that does not enter lens 25, and second parabolic reflection mirror 27 serving as a second reflection mirror which makes the light reflected by first parabolic reflection mirror 26 enter incident surface 23a. Light source apparatus 11 further includes color wheel 24 for time-dividing the light which comes from light pipe 23 into a plurality of color lights to output the light to lens 25 side.

Light pipe 23, which is formed into a tubular shape having a hollow part, includes square incident surface 23a and exit surface 23b. According to the present invention, in light pipe 23, a virtual surface including the opening of the incident side of the hollow part is referred to as incident surface 23a, and a virtual surface including the opening of the exit side of hollow part 34 is referred to as exit surface 23b. Light pipe 23, exit surface 23b of which is formed slightly larger than incident surface 23a, is tapered in an optical axis direction. Light pipe 23 is provided with a reflection surface by forming a reflection film (not shown) on the inner surface of the hollow part. The light which enters incident surface 23a is subjected to multiplex reflection in light pipe 23 by the reflection surface, and then the light that is made uniform in luminance is output from exit surface 23b. Needless to say, when necessary, a solid glass rod may be used in place of light pipe 23.

First parabolic reflection mirror 26 is disposed at a position away from exist surface 23b of light pipe 23 by a predetermined distance in the optical axis direction. First parabolic reflection mirror 26 includes circular opening 26a through which the light from exit surface 23b of light pipe 23 passes to enter lens 25. First parabolic reflection mirror 26 is disposed so that when the ray of the light that is output from exit surface 23b of light pipe 23 and that does not enter lens 25 is extended toward the optical axis side of light pipe 23, the focus of first parabolic reflection mirror 26 can be set at the intersection point of the ray and the optical axis of light pipe 23. In other words, the focus of first parabolic reflection mirror 26 is set on an optical axis close to exit surface 23b in light pipe 23. Thus, a part of the light from exit surface 23b of light pipe 23 reflected by first parabolic reflection mirror 26 advances toward second parabolic reflection mirror 27 at an angle of light that is nearly parallel to the optical axis of light pipe 23.

Second parabolic reflection mirror 27 is disposed between light emitting tube 21 and incident surface 23a of light pipe 23. Second parabolic reflection mirror 27 includes circular opening 27a through which the light from light emitting tube 21 passes to enter incident surface 23a.

Second parabolic reflection mirror 27 is disposed so that a focal position can be set on an optical axis close to incident surface 23a in light pipe 23. Thus, second parabolic reflection mirror 27 reflects the light reflected by first parabolic reflection mirror 26 to enter incident surface 23a of light pipe 23.

Color wheel 24 is disposed between exit surface 23b of light pipe 23 and lens 25. From color wheel 24, the light which comes from light pipe 23 is time-divided into a plurality of color lights having different wavelengths to be output toward lens 25. Aforementioned reflective display element 15 is controlled by a control circuit unit (not shown) to switch image information to be displayed according to the light of each color component transmitted from color wheel 24.

In the embodiment, elliptic reflection mirror 22 is used as converging means for converging the light from light emitting tube 21. However, a condenser lens (not shown) may be used in place of elliptic reflection mirror 22, and the elliptic reflection mirror and the condenser lens can both be used.

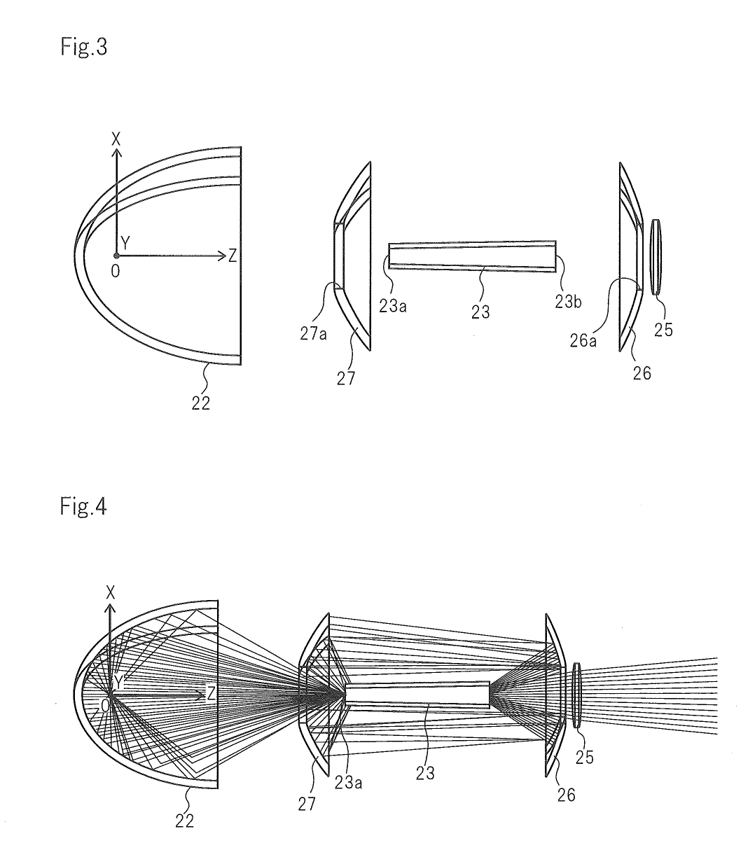

FIG. 3 shows the configuration example of light source apparatus of the embodiment. Table 1 shows the exemplary sizes of elliptic reflection mirror 22, light pipe 23, first and second parabolic reflection films 26 and 27, and lens 25 which comprise light source apparatus 11 shown in FIG. 3. In FIG. 3, directions orthogonal to an optical axis are an X axis direction and a Y axis direction, and an optical axis direction is a Z axis direction. In FIG. 3, the luminescent spot of the light emitting tube is the original point of the X, Y and Z axes.

TABLE 1

| | Position (Z axis | | | |
|---|---|---|---|---|
| | direction) | | | |
| Luminescent spot | 0 | | | |
| Elliptic reflection | −8 | First focus: 0 | Second focus: | Length: 38 |
| mirror 22 | | | 65 | |
| Light pipe 23 | 65 (incident | Incident | Exit surface: | |
| | surface) | surface: 2 × 2 | 2.6 × 2.6 | |
| First parabolic | 125 | Focus: 148 | Length: 4 | Aperture: 7 |
| reflection mirror | | | | |
| Second parabolic | 53 | Focus: 65 | Length: 8 | Aperture: 8 |
| reflection mirror | | | | |
| Lens 25 | 128 | Curvature | Radius: 9 | Thickness: 3 |
| | | radius: 44 | | |

(Unit: mm)

As shown in FIG. 3 and Table 1, in the Z axis direction (optical axis direction), elliptic reflection mirror 22 is formed such that the end of the reflection surface in the (−) direction is disposed at a position of (−) 8 mm from the original point, and the length in the Z axis direction is 38 mm. In the Z axis direction, elliptic reflection mirror 22 is formed such that a first focus is at the luminescent spot, and a second focus is at a position that is 65 mm from the original point.

Light pipe 23 is formed with a length of 40 mm in the Z axis direction. In the Z axis direction, light pipe 23 has incident surface 23a set at a position that is 65 mm and exit surface 23b set at a position that is 105 mm. Incident surface 23a is formed into a square shape of 2 mm×2 mm, and exit surface 23b is formed into a square shape of 2.6 mm×2.6 mm.

In the Z axis direction, the end of first parabolic reflection mirror 26 in the (−) direction is disposed at a position that is 125 mm from the original point, and the focus is at a position that is 148 mm. First parabolic reflection mirror 26 is formed such that the length in the Z axis direction is 4 mm, and the diameter of opening 26a is 7 mm.

In the Z axis direction, the end of second parabolic reflection mirror 27 in the (−) direction is disposed at a position that is 53 mm from the original point, and the focus is at a position that is 65 mm. Second parabolic reflection mirror 27 is formed such that the length in the Z axis direction is 8 mm, and the diameter of opening 27a is 8 mm.

The end of lens 25 in the (−) direction is disposed at a position that is 128 mm from the original point. Lens 25, both surfaces of which are convexed, is formed with a radius of 9 mm, a curvature radius of 44 mm of the convex surface, and a thickness of 3 mm.

The behavior of the rays in light source apparatus 11 of the embodiment thus configured will be described. FIG. 4 schematically shows the behavior of the rays in light source apparatus 11 of the embodiment.

As shown in FIGS. 2 and 4, the light from light emitting tube 21 includes light converged by elliptic reflection mirror 22. This light passes through opening 27a of second parabolic reflection mirror 27 to enter incident surface 23a of light pipe 23. The light incident on light pipe 23 is subjected to multiplex reflection in light pipe 23 to be output from exit surface 23b. The light output from exit surface 23b of light pipe 23 passes through opening 26a of first parabolic reflection mirror 26 to enter lens 25.

A part of the light that is output from exit surface 23b of light pipe 23 and that does not enter lens 25 is reflected on the reflection surface of first parabolic reflection mirror 26. In other words, a part of the light output from exit surface 23b of light pipe 23 applied to the outside of opening 26a of first parabolic reflection mirror 26 is reflected on the reflection surface of first parabolic reflection mirror 26.

The light reflected on the reflection surface of first parabolic reflection mirror 26 advances parallel to the optical axis direction of light pipe 23 to be reflected on the reflection surface of second parabolic reflection mirror 27. The light reflected on the reflection surface of second parabolic reflection mirror 27 enters again incident surface 23a of light pipe 23, and then is output from exit surface 23b of light pipe 23.

Thus, since the part of the light that is output from exit surface 23b of light pipe 23 and that does not enter lens 25 passes through first and second parabolic reflection mirrors 26 and 27 to again enter incident surface 23a of light pipe 23, light use efficiency is improved.

As described above, light source apparatus 11 according to the embodiment includes first parabolic reflection mirror 26 that reflects the part of the light that is output from exit surface 23b of light pipe 23 and that does not enter lens 25, and second parabolic reflection mirror 27 which makes the light reflected by first parabolic reflection mirror 26 enter incident surface 23a. This enables reuse of the part of the light that is output from light emitting tube 21 and that leaks from the optical path without being captured in lens 25. As a result, power consumption can be reduced, and brightness can be improved.

### Second Embodiment

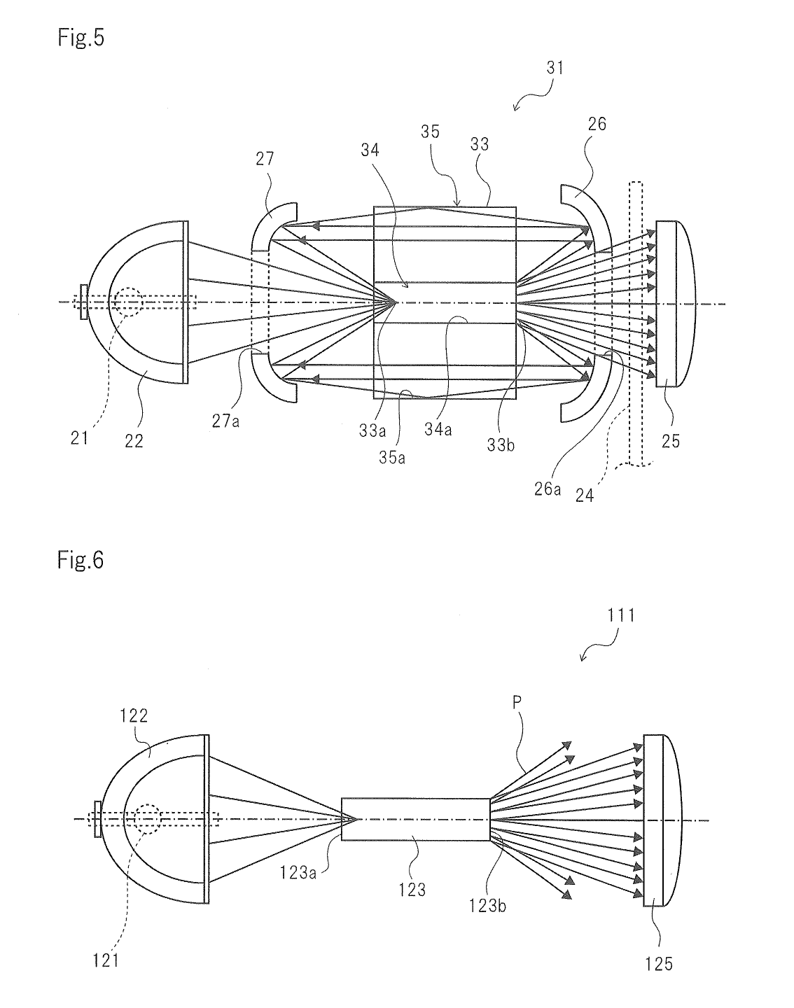

In a second embodiment describing the configuration example of a light source apparatus according to the second embodiment, components similar to those of the light source apparatus of the first embodiment are denoted by similar reference numerals, and description thereof will be omitted. FIG. 5 shows a schematic diagram illustrating the light source apparatus according to the second embodiment.

The second embodiment is different from the first embodiment in that a part of light that is reflected by first parabolic reflection mirror 26 is further reflected on the reflection surface of the light pipe to be guided to second parabolic reflection mirror 27.

As shown in FIG. 5, light source apparatus 31 according to the second embodiment includes light pipe 33 serving as a light guide body including incident surface 33a into which light converged by elliptic reflection mirror 22 enters and exit surface 33b from which light that has entered incident surface 33a is subjected to multiplex reflection to be output.

Light pipe 33 includes hollow part 34 including incident surface 33a and exit surface 33b, and annular part 35 formed on the outer peripheral surface of hollow part 34. In the present invention, in light pipe 33, a virtual surface including the opening of the incident side of hollow part 34 is referred to as incident surface 33a, and a virtual surface 33b including the opening of the exit side of hollow part 34 is referred to as exit surface 33b.

In the inner surface of hollow part 34 of light pipe 33, a reflection film (not shown) is formed to comprise reflection surface 34a from which light that has entered incident surface 33a is subjected to multiplex reflection to be output from exit surface 33b. On the outer peripheral surface of annular part 35 of light pipe 33, a reflection surface (not shown) is formed to comprise reflection surface 35a for reflecting the light reflected by first parabolic reflection mirror 26 toward second parabolic reflection mirror 27.

Thus, a part of the light reflected by first parabolic reflection mirror 26 passes through annular part 35 to enter the reflection surface of second parabolic reflection mirror 27, while the other part of the light reflected by first parabolic reflection mirror 26 is reflected on reflection surface 35a of annular part 35 to enter the reflection surface of second parabolic reflection mirror 27.

In other words, annular part 35 of light pipe 33 transmits the light reflected in a direction parallel to the optical axis of light pipe 33 by first parabolic reflection mirror 26, and reflects the part of the light reflected by first parabolic reflection mirror 26 on second reflection surface 35a.

Light source apparatus 31 according to the second embodiment can provide the same effects as those of light source apparatus 11 according to the first embodiment.

Light pipe 33 according to the embodiment includes reflection surface 35a formed on the outer peripheral surface of annular part 35 to reflect the light reflected by first parabolic reflection mirror 26 toward second parabolic reflection mirror 27. However, when most of the light reflected by first parabolic reflection mirror 26 is reflected in a direction parallel to the optical axis of the light pipe, the formation of the reflection surface on the outer peripheral surface of annular part 35 may be omitted.

In the embodiment, in annular part 35 of light pipe 33, reflection surface 35a is formed to reflect a part of the light reflected by first parabolic reflection mirror 26 toward second parabolic reflection mirror 27. However, this configuration is in no way limitative. Light pipe 23 of the first embodiment may be used in place of light pipe 33, and another reflection mirror (not shown) which has a cylindrical reflection surface independent of light pipe 23 may be provided.

### REFERENCE NUMERALS

1 Projection display apparatus
11 Light source apparatus
21 Light emitting tube
22 Elliptic reflection mirror
23 Light pipe
23a Incident surface
23b Exit surface
24 Color wheel
25 Lens
26 First parabolic reflection mirror
27 Second parabolic reflection mirror

1. A light source apparatus comprising:
a light source;
a light guide body which has an incident surface into which light from the light source enters and which has an exit surface from which light that has entered the incident surface is subjected to multiplex reflection to be output;
an optical element into which the light output from the exit surface enters;
a first reflection mirror that reflects a part of the light that is output from the exit surface and that does not enter the optical element; and
a second reflection mirror which makes the light reflected by the first reflection mirror enter the incident surface.

2. The light source apparatus according to claim 1, wherein:
the first reflection mirror has an opening through which the light from the exit surface of the light guide body passes; and
the second reflection mirror has an opening through which the light from the light source passes.

3. The light source apparatus according to claim 1, wherein the light guide body has a hollow part in which the light that enters the incident surface is subjected to multiplex reflection to be output from the exit surface, and an annular part which is formed on an outer peripheral side of the hollow part and which is configured to transmit the light reflected by the first reflection mirror to enter the second reflection mirror.

4. The light source apparatus according to claim 3, wherein a reflection surface is formed on an outer peripheral surface of the annular part to reflect the light reflected by the first reflection mirror to enter the second reflection mirror.

5. A projection display apparatus comprising:
the light source apparatus according to claim 1; and
an optical modulation element that modulates light from the light source apparatus.

6. An illumination method comprising:
entering light from a light source into an incident surface of a light guide body;
subjecting the light that enters the incident surface to multiplex reflection in the light guide body to output the light from an exit surface; and
entering the light output from the exit surface into an optical element,
wherein a part of the light that is output from the exit surface and that does not enter the optical element is reflected to enter the incident surface.
